(19) United States
(12) Patent Application Publication
(10) Pub. No.: US 2010/0088678 A1
(43) Pub. Date: Apr. 8, 2010

(54) METHOD AND APPARATUS FOR THE FORMAL SPECIFICATION AND ANALYSIS OF TIMING PROPERTIES IN SOFTWARE SYSTEMS

(76) Inventors: Musab AlTurki, Champaign, IL (US); Dinakar Dhurjati, Sunnyvale, CA (US); Dachuan Yu, Santa Clara, CA (US); Ajay Chander, San Francisco, CA (US); Hiroshi Inamura, Kanagawa (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/569,747

(22) Filed: Sep. 29, 2009

Related U.S. Application Data
(60) Provisional application No. 61/103,811, filed on Oct. 8, 2008.

(51) Int. Cl. G06F 9/44

(52) U.S. Cl. 717/124

(57) ABSTRACT

A method and apparatus is disclosed herein for formal specification and analysis of timing properties. In one embodiment, the method comprises receiving a software design that includes timing behaviors expressed in a specification language; analyzing the timing behaviors; and using abstract interpretation based static analysis to detect misuses of one or more timing constructs.

### PRIORITY

The present patent application claims priority to and incorporates by reference the corresponding provisional patent application Ser. No. 61/103,811, titled, “Method and Apparatus for the Formal Specification and Analysis of Timing Properties in Software Systems,” filed on Oct. 8, 2008.

### FIELD OF THE INVENTION

The present invention relates to the field of specification and analysis of timing properties in software systems; more particularly, the present invention relates to a new specification language with formal semantics that can be used to specify and analyze timing behaviors of software systems.

### BACKGROUND OF THE INVENTION

Due to increasing complexity of modern software systems, the likelihood of making errors during a software design phase has increased exponentially. While some of these errors might be detected during testing phase, it is much more cost effective to detect these errors early during design phase. For this reason, formal specification and analysis tools are increasingly being deployed to improve the quality of software design.

Much of the previous work in formal specification and analysis tools has focused on functional aspects of software. However, non-functional aspects of software, in particular timing properties, add another dimension to the problem.

A large body of research and development exists in the area of real-time languages. These languages differ widely in terms of the timing abstractions they support and their semantics depending mainly on their targeted application domains.

In high-level specification languages, such as SDL and UML, the dominating design requirement for timing abstractions is flexibility and expressiveness. In SDL, time can be either dense or discrete and time durations are specified with primitive timers. In UML, however, there is no explicit support for realtime specifications, but the language itself is extensible through its meta-model. In fact, the Real-Time profile (RT UML) extends UML with expressive timing constructs, such as clocks and time constraints

The diversity of timing abstractions and models is even more evident in real-time programming languages. For example, Erlang, which is a programming language based on the Actors model for distributed, soft real-time systems, assumes a discrete time domain, and supports a restricted form of timeout on messages being communicated across nodes. Another closely related language is Esterel, which is a hard real-time programming language for reactive (mostly embedded) systems and based on signals and their presence. A time tick in Esterel is a special kind of signal. (Pure) Esterel uses a delay construct on top of which several other timing constructs can be built. Several other high level languages for real-time systems, such as Ada 2005 and Real-Time Java Specification also exist.

Both SDL and Erlang use timers and check for timer signals as incoming messages. There has also been some attempts at improving the timing abstractions in SDL for specification writers, such as work on extending timers with annotations, for example to specify periodic timers, and supporting urgencies, where transitions can be assigned different urgency levels.

Thus, as discussed above, timing constructs in existing specification languages are either restrictive (e.g., Erlang) or flexible at the cost of allowing many misuses (e.g., SDL), and while several timing analysis tools exist in the literature, there is a gap between the language used by tools and what the current specification languages provide, making it hard to integrate them into current design activities.

### Rewriting Preliminaries

A rewrite theory, a unit of specification in rewriting logic, gives a formal description of a concurrent system including its static state structure and dynamic behavior. A rewrite theory is a tuple [symbol] =(Σ, E, R), with
(Σ,E) a membership equational logic theory with signature Σ and a set of universally quantified equations and/or memberships E. The signature Σ consists of sort and subsort declarations along with operator declarations to be used in the system specification, while equations and memberships E algebraically specify the properties satisfied by these operators. An equation has the form (∀\vec{x})t₁(\vec{x})=t₂(\vec{x}) if C(\vec{x}) with t₁, t₂ terms over Σ with variables (\vec{x}) and C an optional equational condition, whereas a membership is of the form (∀\vec{x})t₁(\vec{x}):s if C(\vec{x}), with s a sort in Σ.
R a set of universally quantified, possibly conditional, rewrite rules specifying the computational behavior of the system. A rewrite rule has the following form:

r:t→t′ if C(1)

where r is a label, and C is a conjunction of equational or rewrite conditions. The operational meaning of such a rewrite rule is that if there exists a substitution θ such that θ(t₁) matches a subterm s in the system (modulo the equations E), and θ(C) is satisfied, then s may rewrite to θ(t₂). A rewrite rule, therefore, gives a general pattern for a possible change or transition in the state of a concurrent.

A real-time rewrite theory extends a regular rewrite theory with support for modeling temporal behaviors of systems. In particular, in a real-time rewrite theory [symbol] ^{τ}=(Σ^{τ},E^{τ}, R^{τ}),
The equational theory (Σ^{τ}, E^{τ}) contains a sort for Time representing the time domain, which can be either dense or discrete. The theory also declares a system-wide operator that encapsulates the whole system being modeled into a special sort GlobalSystem for managing time elapse (see below).
The set of rewrite rules R^{τ} is the disjoint union of two sets R_{I} and R_{T}. The set R_{I} consists of instantaneous rewrite rules having the form (1) above and representing instantaneous transitions in the system that fire and finish at the same instance of time. On the other hand, the set R_{T} consists of tick rewrite rules modeling system transitions that take nonzero amount of time to complete. A tick rewrite rule has the following form

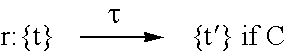

where τ is a term of sort Time representing the duration of time required to complete the transition specified by the rule. The global operator {_} encapsulates the whole system into the sort GlobalSystem to ensure the correct propagation of the effects of time elapse to every part of the system.

For instance, in a simple discrete clock, whose states are given by terms of the form clock(R), time may advance according to the following tick rule

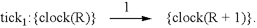

In a slightly more general dense clock, time elapse may be modeled by the following rule instead

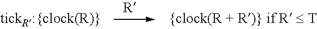

which is a time-nondeterministic rule, as it introduces a new variable R′ on its right-hand side. The rule specifies that, at each tick step, time may advance by any positive value less than some threshold T.

Real-Time Maude (RTM) is a tool that implements real-time rewrite theories. RTM is based on a high-performance implementation of rewriting logic and its membership equational sublogic. Among several other additions, RTM defines a fairly abstract sort TIME along with axioms to represent the time domain, declares the global system operator {_}, and specifies the form of the tick rules and their semantics. A timed module in RTM builds on these features to provide a generic means for the specification of real-time systems.

A particular form of timed modules is object-oriented timed modules, which are declared using the syntax tomod Name . . . tomend. In addition to time, object-oriented timed modules make available the object-oriented specification framework, with which object-oriented systems can be naturally specified.

Under some reasonable executability assumptions, RTM specifications can be simulated and automatically analyzed. Among the analysis tools provided are the timed fair rewrite tfrew, timed and untimed search, and timed model-checking. The tfrew command simulates one possible behavior (a sequence of rewrite steps) of a specification up to a given time bound. The result of a timed rewrite command is the last state in the sequence of rewrites along with a time stamp representing the duration of the rewrites.

The tsearch and utsearch commands perform, respectively, timed and untimed breadth-first search on the reachable state space from given an initial state, while looking for a state matching a given term and satisfying a given semantic condition. While utsearch ignores timing information while examining specification behaviors, tsearch allows searching for states that are reachable within a given time bound. In addition, for both commands, the user may optionally specify a bound on the number of solutions required. The result of the search is either empty, meaning no reachable state satisfies the given requirements, or a list of substitutions for variables in the given pattern that characterize the solution state.

For verifying general time-bounded linear temporal logic (LTL) formulas, representing both liveness and safety properties, RTM provides the timed model-checking command mc T|=t F in time <=R, which checks for satisfiability of the temporal logic formula F along paths starting from the initial state T within the time bound R. The result of the command is true if F is satisfied or otherwise a counter example execution path is given.

Real-time rewrite theories and their implementations in Real-Time Maude have been used in the specification and analysis of various protocols and algorithms, including wireless sensor network protocols, the AER/NCA active network protocol suite, real-time resource-sharing protocols, the real-time CASH scheduling algorithm, and several time-dependent cryptographic protocols.

### SUMMARY OF THE INVENTION

A method and apparatus is disclosed herein for formal specification and analysis of timing properties. In one embodiment, the method comprises receiving a software design that includes timing behaviors expressed in a specification language; analyzing the timing behaviors; and using abstract interpretation based static analysis to detect misuses of one or more timing constructs.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates the abstract syntax of [symbol] .

FIG. 2 illustrates a specification in [symbol] for a client process with timeouts.

FIG. 3 illustrates the instantaneous transition rules.

FIG. 4 illustrates a buggy version of the client example, showing the (internal) intermediate states computed by the mishandled timers analysis.

FIG. 5 is a flow design of one embodiment of a process for software analysis.

FIG. 6 is a block design of one element of a computer system.

### DETAILED DESCRIPTION OF THE PRESENT INVENTION

Methods and apparatus for expressing and analyzing timing properties of complex software systems using a specification language are described together with an integrated analysis framework that makes available a suite of formal analysis tools for software designers. The language constructs for timing are very flexible and suitable for expressing different kinds of timing behaviors. Due to this expressiveness, timing constructs used in other high-level specification languages like SDL and UML can be easily translated into constructs of the specification language described herein.

In one embodiment, the formal semantics of the language are defined using a real-time rewrite theory. Since real-time rewrite theories are executable in logical frameworks such as Real-Time Maude, the framework automatically supports trace analysis and simulation of timing behaviors for specifications. Furthermore, the timed model checker for Real-Time Maude can be readily used for analyzing and verifying various real-time properties of the specifications. Thus, the integrated analysis framework facilitates the use of formal specification tools by reducing the gap between the specification language and the language used by the verification tools. Finally, since the timing constructs are intended to be very flexible, there is a possibility of misusing the constructs. To prevent such misuse, static analysis tools based on abstract interpretation are used to check for common usage errors.

Embodiments of the framework has the following significant benefits: a) it is expressive, b) it supports trace analysis and simulation of timing behaviors, c) allows for verification of properties of specification, and d) checks for common usage errors of timing constructs.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### An Introduction to a Specification Language

In the following, a high-level specification language [symbol] is described that is well-suited for describing a spectrum of behaviors of a wide range of software systems, including their timed behaviors. [symbol] is a concurrent specification language serves as a formal programming model for various user-level specification languages, such as SDL and UML. The language provides a unified specification framework for the analysis and verification of such higher-level specifications.

While the language supports several imperative features for describing sequential computations, in one embodiment, concurrency in [symbol] is modeled by asynchronously communicating processes that can be dynamically created or destroyed. A process maintains a thread of sequential computation representing a simple component in software. A process may create another process with a specified computational behavior, or may destroy itself. Processes communicate by exchanging asynchronous messages, and use timers as the basic timing abstraction to account for timing behaviors.

Beside providing a core language with formal semantics for specification creation, management, and analysis, the simplicity of [symbol] directly translates into a simple formal model that can easily analyzed and manipulated. Furthermore, it is an expressive language that is potentially capable of formally capturing user-level software specifications given in various specification languages.

One embodiment of the syntax and semantics of [symbol] are described below.

### SYNTAX AND EXAMPLES

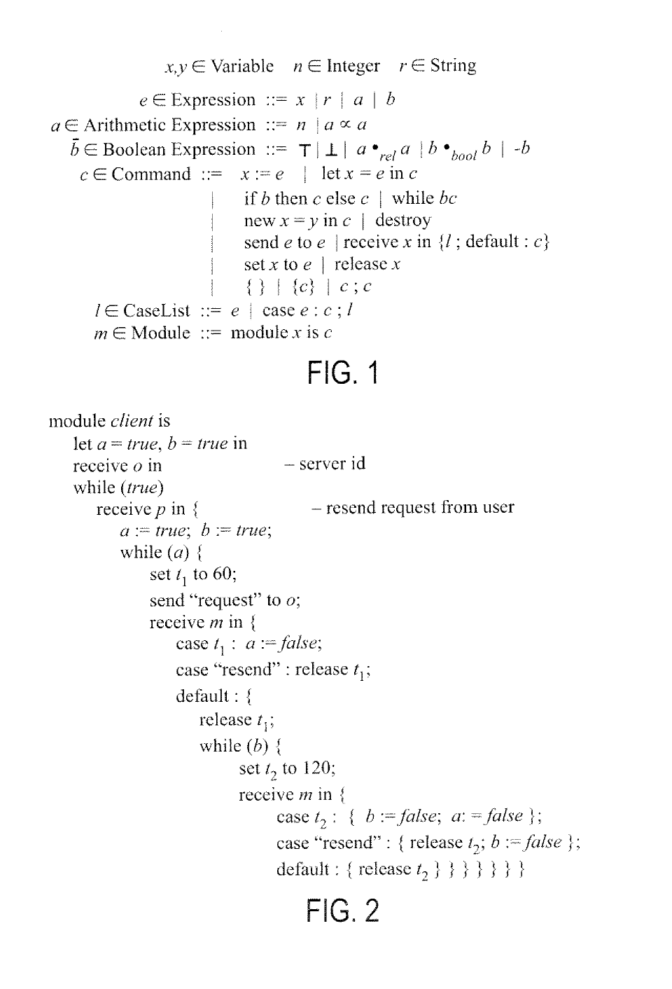

FIG. 1 illustrates the syntax of the concurrent language. A constant expression in [symbol] can be either an integer value, a Boolean value (T or ⊥), or a variable name. Complex expressions can be constructed using standard arithmetic, relational, and boolean composition operators.

Unlike expressions that evaluate to some constant value, commands do not produce values, but can have side effects. A command in [symbol] can be an assignment statement, a scoped declaration of a variable using a let statement, a conditional statement, or a while loop statement. The language also has a few process-level commands, which include creating a new process, destroying the current process, sending a message to a process, and receiving a message. The body of the receive statement may consist of a list of exclusive case statements followed by a default statement. Furthermore, commands can be grouped into command blocks, and sequenced using the semicolon as a sequencing operator. Finally, a specification in [symbol] may use an optional list of module declarations, serving as templates for newly created processes.

A variable x is bound in c in the commands let x=e in c and new x=y in c, and is bound in c and s of the receive command. Variables used in set and release, called timer variables, are globally scoped variables and are assumed to be distinct in a given specification for it to be meaningful. For purposes herein, a variable is said to be free if it is not bound.

For compactness, we use if b then c as syntactic sugar (different syntax for the same construct but is easier to read) for a conditional with an empty else branch, and receive x in c to denote a receive statement with no case branches, i.e. receive x in {ε; default:c}.

FIG. 2 illustrates an example specification in [symbol] referred to as CLIENT, that defines a client process that interacts with the user and a server, and timeouts responses from the server, for which the client process maintains two timers t₁ and t₂. Upon receiving a “resend” request from the user, the process forwards a request to the server and sets a timeout of 60 time units for the first response from the server using the timer variable t₁. There are three possibilities at this point: (1) a timeout occurs, which is indicated by the incoming signal t₁, and at which case the process restarts and waits from another request from the user; (2) another request from the user is received, at which case the client resets the timer t₁, and sends a request to the server; (3) a response from the server is received, at which case t₁ is dropped and a similar process is initiated for subsequent responses from the server using another timer t₂. For simplicity, the example does not specify how the client actually processes incoming responses from the server.

The CLIENT example above is referred to throughout the application to illustrate various aspects of the specification framework. Below, a more precise description of the semantics of [symbol] is given.

### Formal Semantics of One Embodiment of the Specification Language

The formal semantics of [symbol] are given as an object-oriented real-time rewrite theory [symbol] , which has an efficient implementation in Real-Time Maude. The semantics are distributed and concurrent in that a state for a specification in [symbol] consists of one or more process objects that are executed concurrently, and which may interact with each other as time elapses.

### Semantic Infrastructure

A sort V of values are fixed to represent the different values manipulated by a specification in [symbol] . A value vεV can be an integer value vᵢ, a string value vₛ, a boolean value v_{b}, a time value vₜ, or a process identifier value vₚ. Lists of values can be constructed as fully associative lists of comma-separated values with an identity element nil.

An environment σ is a mapping from variable names to values, specified in [symbol] as an associative list of entries of the form [x, v] with identity nil. Within an environment, a variable may be referenced in multiple entries with the intended meaning that later entries mask earlier ones for that variable. This provides a convenient, operational method for managing nested scopes within a specification. Indeed, new scoped variable declarations can be introduced by pushing a new entry onto the environment list, while popping an entry signifies reaching the end of the scope of a variable.

A few notational assumptions are in order. The notation σ[x] is used to denote the value to which x is mapped in a if it exists, while the notation σ[x←v] denotes an environment that is identical to a except possibly at x, where x is now mapped to v. A new entry may be pushed onto an environment a using the notation σ[x, v], whereas popping out the last entry of (a non-empty) σ is denoted by pop(σ). The evaluation of an expression e using an environment σ is denoted by e↓_{σ}.

A state in the system is represented by a configuration consisting of a multi-set of objects and messages. The fundamental class of objects within a configuration is the Process class. In one embodiment, in addition to the process object identifier, a process object contains the following fields: a name, an environment, a command, a field for the timer set of the process, and a queue of incoming messages, and a process object has the following form:

[symbol]

id:Process|name:x,env:σ,cmd:c,tmr:T,msg:M

[symbol]

The queue of messages M is simply a list of values. The set T is a (possibly empty) set of timer records of the form {x, vₜ}, with vₜ a time value. A timer record in T represents an active timer, which is a timer that has been started but is yet to expire or be handled.

Besides process objects, a configuration contains a Declarations object, which maintains globally visible module declarations that can be instantiated when creating new process objects.

### Instantaneous Transition Rules

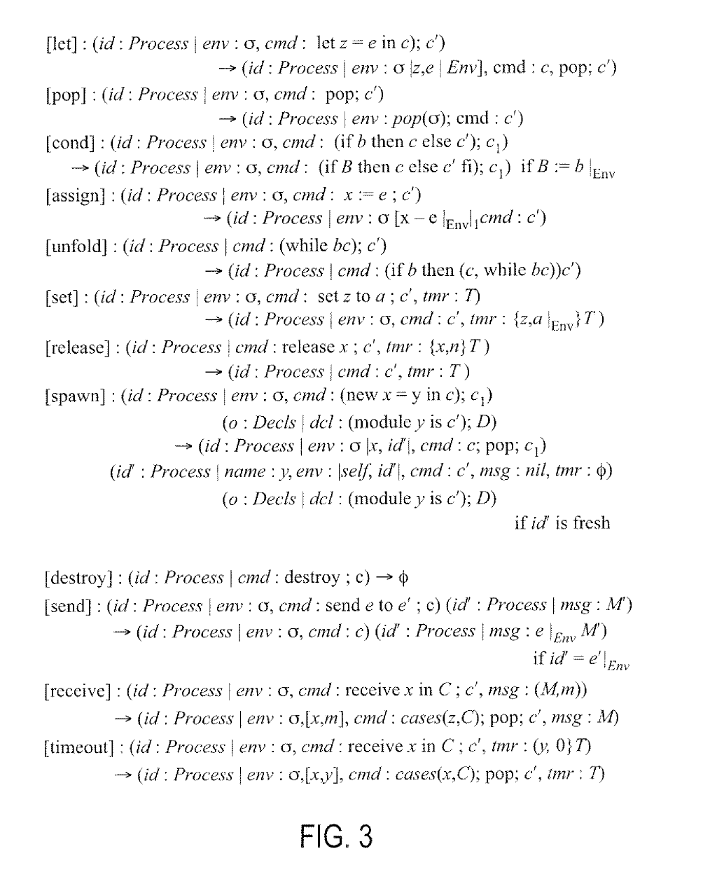

In [symbol] , instantaneous transitions of [symbol] are modeled by regular rewrite rules, which are shown in FIG. 3. The rules specify the behavior of a process within a configuration based on the next command to be executed by that process. Referring to FIG. 3, the command field cmd of a process serves as a continuation that defines what to be done next. The rules are given in the object-oriented specification style, in which specifications are given at the level of the least specific type. Attributes within a process object that do not play a role in the rewrite rule are not mentioned to avoid obscuring the present invention.

Most of the rules in FIG. 3 are self-explanatory. However, we make the following observations. A new construct pop is used as a continuation item to internally manage scoping of variables. Moreover, the rule for the conditional statement [cond] has a matching equation as its condition, which first reduces its right-hand side to normal form and then matches it against the pattern given on its left-hand side, which in this case is just a variable. The rules [receive] and [timeout] add a source of non-determinism to the behavior of a process since now a receive command may non-deterministically choose to consume a timer signal or an incoming message if both are available to be processed.

### Timed Semantics

As shown above, time in real-time rewrite theories is represented by the sort Time, and time elapse is modeled by tick rules. For [symbol] , assuming R is a time value and C is a configuration, the tick rule that models time elapse and its effects is as follows:

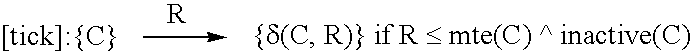

The following observations are made:
The function δ equationally propagates the effect of a time tick to all objects within the configuration C, which comprises decreasing all timer values within all process objects by amount R of the tick.
The function mte equationally defines the maximum time elapse until the next event of interest. This is a standard technique in RTM to specify upper bounds on how much a clock is allowed to advance before the next event in the configuration. In this case, the mte of a configuration of processes is determined by the timer with the minimum time value among all sets of timers in all processes.

mte(T{x,vₜ})=min(mte(T),vₜ)

mte(φ)=∞
The predicate inactive distinguishes states in which instantaneous (untimed) transitions are enabled (also called active states) from those in which the only possible transition is a tick transition advancing time (inactive states). The predicate is used to restrict applications of the tick rule to inactive states so that instantaneous transitions have precedence over time tick transitions. This is to maintain the expected semantics of timers and to prune uninteresting behaviors in which a configuration might appear to be progressing while it is not (for example, advancing time without doing anything else). This semantics enforces the fact that when a timer in a process expires, its signal cannot be ignored and must be handled, either by releasing the timer or by consuming its signal. For these semantics to be fully meaningful, however, configurations may only assume non-Zeno behaviors (which are behaviors in which time will always eventually have a chance to advance), which is a common assumption for real-time specifications with logical time.

### A Prototype in Real-Time Maude

Real-Time Maude (RTM) provides a highly efficient implementation of real-time rewrite theories. A prototype in RTM for [symbol] is described that corresponds to the specification [symbol] described above. As an immediate consequence of specifying the formal semantics of the [symbol] in RTM, a simulator and several formal analysis tools are essentially obtained for free. In particular, RTM provides tools to perform timed simulations, explore state spaces with or without regards to time, and to model-check finite-state specifications against time-bounded linear temporal logic formulas.

The prototype is specified as a real-time object-oriented module [symbol] in RTM, which is directly based on [symbol] with similar structure and notational conventions but in typewriter form. Although complex time models and sampling strategies can be used in [symbol] , a few assumptions are made in the prototype to simplify analysis. In one embodiment, it is assumed that the time domain is a discrete time domain, implemented using the domain of natural numbers extended with infinity, which can be specified by letting the module [symbol] extend RTM's predefined module NAT-TIME-DOMAIN-WITH-INF. In addition, the time sampling strategy is assumed to be a simple time sampling strategy that visits every discrete instance of time. In RTM, this corresponds to the default mode time sampling strategy with unit time increments, which is specified using the following command:

(set tick def 1.)

The CLIENT specifications given in FIG. 2 are used to illustrate the use of such formal tools. The reference client is used to denote its specification in [symbol] . Since client is a template for a reactive process that communicates with a user and a backend server, an initial configuration system is assumed in which a user object and a server object are defined in order to be able to perform analysis on client. The initial configuration contains a server process object that upon receiving a request sends out five responses, five time units apart, and a user process object that sends two “resend” requests, the first at time 1, and the other at time 20.

To simplify the presentation of the analysis, another object, called the Observer object, is used to record traces of events of interest along with their timestamps.

### Simulation and Prototyping

A sample run of system for a duration of 200 time units can be obtained by issuing the following command (where some of the output is omitted for brevity):

```
Maude> (tfrew system in time <= 200 .)
...
Result ClockedSystem :
{...
  < od : Decls | dcl : module ‘client is ..., module ‘server is ...,
                module ‘user is ...>
  < oo : Obser | out :([6 : vstring(“t1: first response received”)]
                  [11 : vstring(“t2: response received”)]
                  [16 : vstring(“t2: response received”)]
                  [21 : vstring(“t2: resend before it expires”)]
                  [21 : vstring(“t1: first response received”)]
                  [26 : vstring(“t2: response received”)]
                  [31 : vstring(“t2: response received”)]
                  [36 : vstring(“t2: response received”)]
                  [41 : vstring(“t2: response received”)]
                  [161 : vstring(“t2: expired”)]) >
  < p(1): Process | name: ‘client, cmd: receive p in ... , tmr: mt >
  < p(2): Process | name: ‘server, cmd: receive m in ... , tmr: mt >
  < p(3): Process | name: ‘user, cmd: { }, ... , tmr: mt >}
in time 200
```

The result above shows that after 200 clock ticks, the system reaches a quiescent state where no more message exchanges exist or are scheduled, and no timers are yet to be set or processed. As shown in the recorded trace, a “resend” request from the user was received at time 21 while the client was processing the third response from the server, immediately after which the client resent the request and restarted processing. Since the server sends only five responses to a given request, the timeout at time 161 after the fifth response had been received at time 41 is shown.

Furthermore, using timed search, one can verify, starting from system, the property that the system will in fact never be in a quiescent state before that.

```
Maude> (tsearch system =>+ { CF:Configuration } such that
      inactive({CF:Configuration}) and noAliveTimer(CF:Configuration)
      in time <= 160 .)
rewrites: 292369 in 889ms cpu (890ms real) (328554 rewrites/second)
No solution
```

Above, the arrow =>+ means states reachable by one or more rewrites from the given state. The semantic condition inactive(CF) and noAliveTimer(CF) captures exactly what it means for a state to be quiescent.

Using untimed search, a check can be made as to whether, along some execution path, the client will actually reach a state at which the server ceases to send any more messages.

```
Maude> (utsearch [1] system =>+ { CF:Configuration < oo : Obser | out :
                (O:Output [R:Time : vstring(“t2: expired”)]) > } .)
rewrites: 196912 in 750ms cpu (751ms real) (262239 rewrites/second)
Solution 1
CF:Configuration --> ...
  < p(1): Process | name : ‘client, cmd : ... >
  < p(2): Process | name : ‘server, cmd : ... >
  < p(3): Process | name : ‘user, cmd : ... > ;
O:Output --> [6 : vstring(“t1: first response received”)]
              [11 : vstring(“t2: response received”)]
              [16 : vstring(“t2: response received”)]
              [21 : vstring(“t2: resend before it expires”)]
              [26 : vstring(“t1: first response received”)]
              [31 : vstring(“t2: response received”)]
              [36 : vstring(“t2: response received”)]
              [41 : vstring(“t2: response received”)];
R:Time --> 161
...
```

The command above searches for exactly one such solution, which turns out to be the solution given by rewrite command above.

### Model Checking Analysis

RTM also provides powerful time-bounded model-checking tools for verifying general linear temporal logic (LTL) formulas, representing both liveness and safety properties, which can be immediately applied to specifications in [symbol] . The LTL formulas are based on a set of atomic propositions that capture state properties of interest and a labeling function that assigns to each state in the system a subset of atomic propositions that are true in that state. Given a module M for some specification in [symbol] , this is done in RTM by defining a module M′ that imports the module M and the internal module TIMED-MODEL-CHECKER and specifies equationally the meanings of these propositions and the labeling function. For the running example, the module system, model checking is performed against a module extension of the form:

```
(tomod MODEL-CHECK-CLIENT is
  including TIMED-MODEL-CHECKER .
  protecting CLIENT .
  ...
  endtom)
```

where “including” and “protecting” represent module extension modes. The internal module TIMED-MODEL-CHECKER declares sorts for states State, atomic propositions Prop, logical formulas Formula to which the various LTL operators belong, and the logical time-bounded satisfaction operator |=t, among several other things. Thus, within the module above, one can declare the following two propositions (the keywords op, var, and eq introduce, respectively, operator declarations, variable declarations, and equations in Maude):

```
op first-response : -> Prop .
op timeout : -> Prop .
var CF : Configuration . var O1 O2 : Output . var R : Time .
eq {CF < oo : Obser | out :(O1 [R : vstring(“t1: first response
      received”)] O2) > } |= first-response = true .
eq {CF < oo : Obser | out :(O1 [R : vstring(“t2: expired”)] O2) > } |=
      timeout = true .
```

The first proposition first-response is true in a state in which the client has already received its first response from the server, while the other proposition timeout is true in a state where the second timer has expired. States in which a proposition does not hold need not be specified.

Using these propositions, a property about the system modeled can be verified by client: it is always the case that within the first 200 time units and after receiving the first response from the server, the second timer will eventually expire. This property holds since the server will cease to send out responses after the first response, causing the client to eventually timeout. This can be checked automatically using the model-checking command:

Maude> (mc system |=t [ ] (first-response => <> timeout) in time
<= 200 .)
rewrites: 224937 in 836ms cpu (837ms real) (268782 rewrites/second)
Result Bool : true

where [ ] denotes “always”, => “implication”, and < > the “eventually” operator. However, the property does not hold if we restrict traces to 100 time units. The corresponding model-checking command presents a counter example trace to that effect:

```
Maude> (mc system |=t [ ] (first-response => <> timeout)
in time <= 100 .)
rewrites: 45801 in 6159ms cpu (6160ms real) (7436 rewrites/second)
Result ModelCheckResult :
  counterexample({{< od : Decls | dcl :(( module ‘client is let a = true
  in let b = true in receive o in while(true) receive p in { a := true ;
  ...
  [self,vpid(3)],msg : nil,name : ‘user,tmr : mt >} in time 100,‘tick})
```

### Proper Use of Timing Abstractions

In order to be able to model a wide range of software systems with real-time components, the timing abstractions and constructs of [symbol] are designed so that they are expressive and flexible. However, such flexibility might enable unintended or undesirable usage patterns of these abstractions and constructs. The following discusses possible usage problems with timers and discuss automatic means for checking for them.

Referring back to the working example specification CLIENT shown in FIG. 2, there are several possible misuses of timer-related constructs in CLIENT which would render the specification erroneous or unnecessarily complex. For instance, by dropping any one of the release commands in this specification or by dropping any one of the receive case branch statements, possible execution paths are introduced along which a timer is set but never released or processed. Moreover, by adding any new release command or case statement to this specification, dead code is introduced that is either superfluous or even unreachable along any execution path in the specification.

The problem, which is referred to herein as Mishandled Timers, identifies usage patterns of timers that could potentially cause semantic or structural problems with specifications in [symbol] . It consists of three sub-problems:
1. Unhandled timers: a timer is not properly handled in a specification if there exists a possible execution path along which a timer is set but then neither dropped with a release command, nor its signal is ever consumed.
2. Extra release commands: a release command is extra if it attempts to drop a timer that is always properly handled along all execution paths to it.
3. Unreachable case branches: a receive case branch is unreachable if the timer whose signal is being checked is always properly handled along all execution paths to that case branch.

In one embodiment, the mishandled timers problem are formulated as a data-flow analysis problem, and therefore are checked automatically using standard static analysis with a general static analysis framework integrated with the specification language [symbol] . Below is one embodiment the static analysis framework and its instantiation to the mishandled timers problem are described.

### Static Analysis of Specifications in

The formal analysis tools and techniques provided by RTM and described above are very useful for analyzing any given specification in [symbol] and verifying properties about it. However, due to the dynamic nature of the analysis, such properties are necessarily specific to the specification in hand, and an initial state must be constructed for them to be performed. For example, for CLIENT, the property that the system will never be in a quiescent state before 160 time units have passed applies only to this specification and was verified against one possible instance of the problem given by the initial state defined by system.

In one embodiment, another class of formal verification techniques with which generic properties can be automatically verified is obtained through static analysis, which allows for the verification of a different class of properties dealing with the proper use of constructs in [symbol] . In one embodiment, the static analysis used is based on the well-studied framework of Abstract Interpretation, which provides a powerful tool for automated analyses and a formal framework for proving their correctness with respect to a given concrete formal semantics. The framework enables building a safe approximation of a given concrete semantics, so that if a property holds in the abstract semantics, it also holds in the concrete semantics. In practice, the process of building safe abstractions for a given property involves defining a finite abstract domain, typically a lattice, along with its associated partial ordering relation and join operation, and then defining for each language construct a monotonic transfer function on this domain, which approximates its execution with respect to the that property.

Control flow graphs (CFGs) of specifications in [symbol] are used to build generic abstract interpretations of their concrete semantics, which can be specialized to perform various data-flow analyses. A CFG for a specification S provides a static representation of all possible dynamic behaviors of S, consisting of a set of nodes, representing commands in S, and a set of directed edges, representing possible immediate flows between commands.

CFGs provide a convenient structure for carrying out data-flow analysis. While the effects of the individual commands (or basic blocks) in S are captured by transfer functions, the effects of flow of control are captured by equations relating the exit and entry points of two adjacent nodes in the graph. Since CFGs may contain cycles (while loops, for example), the solution to such data-flow analysis equations typically requires iteratively computing a fixed point solution, which is guaranteed to exist if the abstract domain forms a lattice and all transfer functions are monotonic.

In one embodiment, the abstraction framework for [symbol] is specified as an equation theory and implemented it in Maude as a functional module. The module defines an operator cfg, which, given a specification in [symbol] , builds a flattened graph as a set of nodes and directed edges grouped together using the associative and commutative empty juxtaposition operator with identity mtg. A node in a CFG is a pair <I:B>, consisting of an identifier I and a statement B corresponding to the basic block represented by that node, while a directed edge is a triple [I1:S:I2], consisting of identifiers I1 and I2 for the source and target nodes, respectively, and an abstract state S on that edge, which is used for analysis. The CFG construction process is defined inductively over the structure of commands in [symbol] . Once the CFG is constructed, computation of fixed points is specified by straight-forward equations that are mostly facilitated by Maude's efficient associative-commutative matching algorithms on the flattened graph. For instance, the following equation specifies the effect of the assignment command (ceq introduces a conditional equation):

ceq[I1:S:I]<I:x:=e>[I:S′:I2]=[I1:S:I]<I:x:=e>[I:S″:I2]

if s″:=assign(S, x, e)/\S′<s″.

where assign (S, x, e) is the transfer function for assignment and < is the strict partial ordering relation on abstract states. The particular definitions of transfer functions, abstract states, and the ordering relation are dependent on the specific property to be analyzed and are therefore left unspecified in the abstraction framework. Below, an instantiation of it is given for the analysis of the mishandled timers problem.

### Mishandled Timers

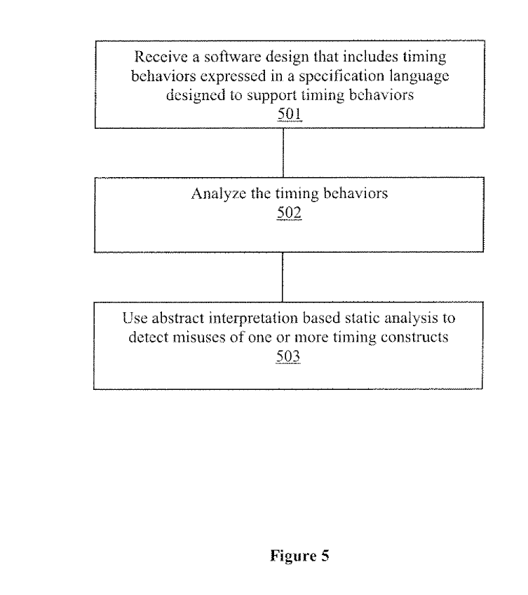

The mishandled timers problem is formulated as a data-flow analysis problem, and the abstract interpretation framework described above is used to automatically check for it. FIG. 5 is a flow diagram of one embodiment of a process for analyzing timing properties in software. The process is performed by programming logic that may comprise hardware (circuitry, dedicated logic, etc.), software (such as is run on a general purpose computer system or a dedicated machine), or a combination of both.

Referring to FIG. 5, the process begins by receiving a software design that includes timing behaviors expressed in a specification language designed to support timing behaviors (processing block 501). Using this, processing logic analyzes the timing behaviors (processing block 502). In one embodiment, analyzing the timing behaviors includes abstracting timer values and using the model checker for some properties. In another embodiment, analyzing timing behavior is performed by using abstract interpretation based static analysis for some other properties. In the mishandled timers problem, only this later analysis is used and the model checker is not used. Then processing logic uses abstract interpretation based static analysis to detect misuses of one or more timing constructs (processing block 503). Thus, the timing behaviors are derived from at least one timer, which is a data structure associated with a timer value that is set and released via separate operations. The timer value is modified based on clock ticks, and after expiration, the timer is ready to be consumed.

In one embodiment, misuses of one or more timing constructs comprise mishandling of one or more of the timers. As will be discussed in more detail below, mishandling of a timer may be due to an unreachable or superfluous code having a timer, code having extra release commands associated with a timer; and code having an unhandled timer. In one embodiment, the static analysis computes, at each point in a specification, a set of one or more timers that may not have been handled properly on a path to that point in the specification.

In one embodiment, the analysis computes, at each point in the given specification, the set of timers that may have not been properly handled on some path to that point in the specification. By computing such intermediate states, decision procedures are built to detect misuses of timers. In particular, to detect unhandled timers, the state at exit point of the specification is checked; if it is not empty, then there is at least one unhandled timer. On the other hand, for the detection of an extra release statement or an unreachable case branch, the state at the entry point of the statement or the branch is checked; if it does not include the timer of interest, then the statement is problematic.

Such decision procedures are obtained by formally specifying the mishandled timers analysis problem as follows. The abstract domain is defined to be a simple lattice of T and ⊥, with the usual ordering. The abstract state is a valuation from timer variable names to values in the lattice. A timer variable is mapped to T in an abstract state if it references a timer that may not have been handled in that state. Otherwise, it is mapped to ⊥. Both the lattice ordering and the join operation are extended in the usual way to abstract states.

Then, for each command in [symbol] , the transfer function is defined that specifies the effect of that command on the abstract state. Most of these functions are fairly trivial to define for this problem since almost all functions are the identity functions on states, except for the commands set and release, for which the transfer functions set (S, x, e) and release (S, x) are defined as follows:

eq set(S[x,v],x,e)=S[x,top].

eq set(S,X,e)=S[x,top][owise].

eq release(S[x,v],x)=S[x,bot].

eq release(S,x)=S[x,bot][owise].

where set maps the variable name being set to T, and release maps it to ⊥. The transfer function if (S, e, b) for the conditional command is also defined to reflect the possible change in state in the true and false branches of several other commands, such as receive case statements:

eq if(S, expired(x), true) = expired(S, x) .
eq if(S, e, b) = S [owise] .
eq expired(S[x,v], x) = S[x,bot] .
eq expired(S, x) = S[x,bot] [owise] .

To complete the required setup for the mishandled timers problem analysis, the following operators are defined that will automatically check its three subproblems: (1) the operator utimers, which returns the computed abstract state at the end of the specification being analyzed, (2) the operator ers, which returns a set of nodes in the control flow graph corresponding to extra release commands, and (3) the operator ecs, which returns a set of nodes in the control flow graph corresponding to unreachable case branches.

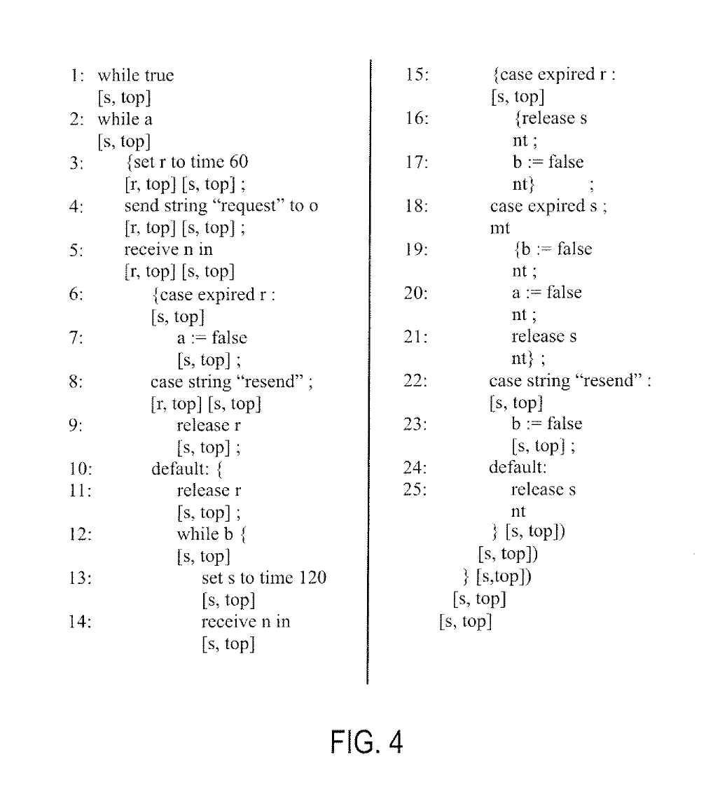

To illustrate the use of these operators, they are applied to a variation, named Buggyclient with timers r and s, of the client specification to which we introduced some instances of the mishandled timers problem. This specification and the internal results of the analysis algorithm are shown in state-decorated syntax in FIG. 4. As is shown in FIG. 4, timer s is not properly handled, which can be automatically realized by the command

Maude> red utimers(cfg(BuggyClient)) .
rewrites: 47660 in 58ms cpu (59ms real) (807919 rewrites/second)
result State: [s,top]

and which is resulting from a missing release statement within the case branch labeled 22. Moreover, the release command labeled 21 is extraneous, which can be checked by issuing the command:

Maude> red ers(cfg(BuggyClient)) .
rewrites: 47675 in 59ms cpu (59ms real) (794702 rewrites/second)
result Node: < 21 : release* s >

Finally, the case branch labeled 15 is unreachable, as shown by the following command:

Maude>red ecs(cfg(Buggyclient)).

rewrites: 47669 in 58 ms cpu(58 ms real)(808072 rewrites/second)

result Node: <15:case(14, expired r)>

### An Example of a Computer System

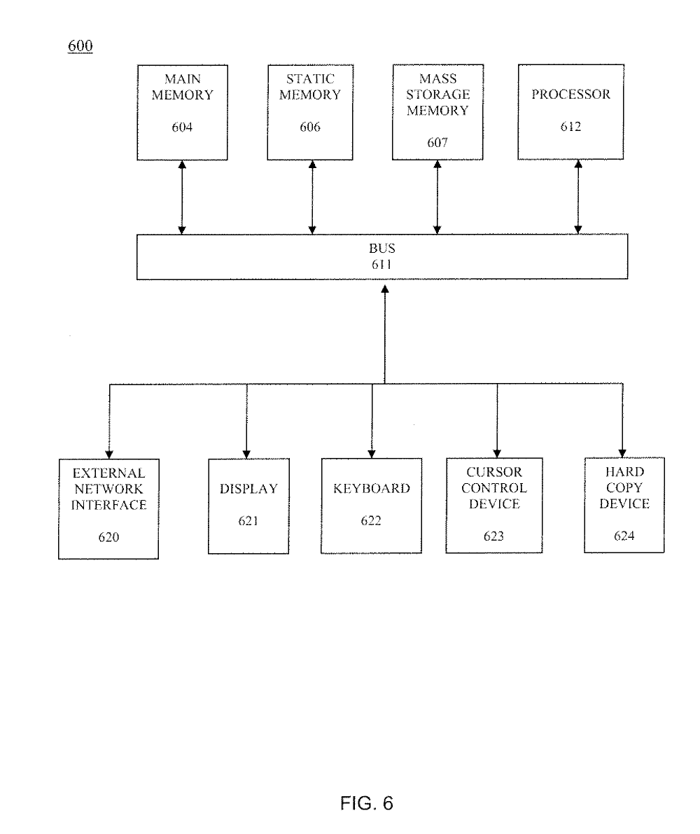

FIG. 6 is a block diagram of an exemplary computer system that may perform one or more of the operations described herein. Referring to FIG. 6, computer system 600 may comprise an exemplary client or server computer system. Computer system 600 comprises a communication mechanism or bus 611 for communicating information, and a processor 612 coupled with bus 611 for processing information. Processor 612 includes a microprocessor, but is not limited to a microprocessor, such as, for example, Pentium™, PowerPC™, Alpha™, etc.

System 600 further comprises a random access memory (RAM), or other dynamic storage device 604 (referred to as main memory) coupled to bus 611 for storing information and instructions to be executed by processor 612. Main memory 604 also may be used for storing temporary variables or other intermediate information during execution of instructions by processor 612.

Computer system 600 also comprises a read only memory (ROM) and/or other static storage device 606 coupled to bus 611 for storing static information and instructions for processor 612, and a data storage device 607, such as a magnetic disk or optical disk and its corresponding disk drive. Data storage device 607 is coupled to bus 611 for storing information and instructions.

Computer system 600 may further be coupled to a display device 621, such as a cathode ray tube (CRT) or liquid crystal display (LCD), coupled to bus 611 for displaying information to a computer user. An alphanumeric input device 622, including alphanumeric and other keys, may also be coupled to bus 611 for communicating information and command selections to processor 612. An additional user input device is cursor control 623, such as a mouse, trackball, trackpad, stylus, or cursor direction keys, coupled to bus 611 for communicating direction information and command selections to processor 612, and for controlling cursor movement on display 621.

Another device that may be coupled to bus 611 is hard copy device 624, which may be used for marking information on a medium such as paper, film, or similar types of media. Another device that may be coupled to bus 611 is a wired/wireless communication capability 625 to communication to a phone or handheld palm device.

Note that any or all of the components of system 600 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving a software design that includes timing behaviors expressed in a specification language;
analyzing the timing behaviors; and
using abstract interpretation based static analysis to detect misuses of one or more timing constructs.

2. The method defined in claim 1 wherein analyzing the timing behaviors is based on abstracting timer values for model-checking.

3. The method defined in claim 2 further comprising using a timed model checker to verify timing properties of specifications.

4. The method defined in claim 1 wherein analyzing the timing behaviors is performed using abstract interpretation based static analysis.

5. The method defined in claim 1 wherein the timing behaviors are derived from at least one timer, the timer being a data structure associated with a timer value and being set and released via separate operations, the timer value being modified based on clock ticks, and further wherein the timer is consumable after expiration.

6. The method defined in claim 1 wherein misuses of one or more timing constructs comprises mishandling of one or more timers.

7. The method defined in claim 6 wherein mishandling of one or more timers are due to one of a group consisting of: an unreachable or superfluous code having a timer, code having extra release commands associated with a timer; and code having an unhandled timer.

8. The method defined in claim 1 wherein the static analysis computes, at each point in a specification, a set of one or more timers that may not have been handled properly on a path to that point in the specification.

9. The method defined in claim 1 wherein the static analysis is performed using a control flow graph representing a specification.

10. The method defined in claim 9 further comprising building a graph with a set of nodes and directed edges grouped together and specifying computation of fixed points.

11. An article of manufacture having one or more storage media storing instructions thereon which, when executed by a system, cause the system to perform a method comprising:
receiving a software design that includes timing behaviors expressed in a specification language;
analyzing the timing behaviors; and
using abstract interpretation based static analysis to detect misuses of one or more timing constructs.

12. The article of manufacture defined in claim 11 wherein analyzing the timing behaviors is based on abstracting timer values for model-checking.

13. The article of manufacture defined in claim 12 wherein the method further comprises using a timed model checker to verify timing properties of specifications.

14. The article of manufacture defined in claim 11 wherein analyzing the timing behaviors is performed using abstract interpretation based static analysis.

15. The article of manufacture defined in claim 11 wherein the timing behaviors are derived from at least one timer, the timer being a data structure associated with a timer value and being set and released via separate operations, the timer value being modified based on clock ticks, and further wherein the timer is consumable after expiration.

16. The article of manufacture defined in claim 11 wherein misuses of one or more timing constructs comprises mishandling of one or more timers.

17. The article of manufacture defined in claim 16 wherein mishandling of one or more timers are due to one of a group consisting of: an unreachable or superfluous code having a timer, code having extra release commands associated with a timer; and code having an unhandled timer.

18. The article of manufacture defined in claim 11 wherein the static analysis computes, at each point in the specification, a set of one or more timers that may not have been handled properly on a path to that point in the specification.

19. The article of manufacture defined in claim 11 wherein the static analysis is performed using a control flow graph representing the specification.

20. The article of manufacture defined in claim 19 wherein the method further comprises building a graph with a set of nodes and directed edges grouped together and specifying computation of fixed points.

21. An apparatus comprising:
a memory to store executable instructions and data; and
a processor coupled to the memory, to execute the instructions to perform a method that includes
receiving a software design that includes timing behaviors expressed in a specification language;
analyzing the timing behaviors; and
using abstract interpretation based static analysis to detect misuses of one or more timing constructs.
